(19) United States
(12) Patent Application Publication
(10) Pub. No.: US 2012/0030550 A1
(43) Pub. Date: Feb. 2, 2012

(54) METHOD FOR EDITING MULTIMEDIA

(76) Inventors: Ai CHIN, Hsinchu City (TW); To Chin, Hsinchu City (TW)

(21) Appl. No.: 13/176,075

(22) Filed: Jul. 5, 2011

Related U.S. Application Data
(60) Provisional application No. 61/400,365, filed on Jul. 28, 2010.

(51) Int. Cl. G06F 17/00

(52) U.S. Cl. 715/202

(57) ABSTRACT

A method for editing multimedia includes the following steps. First, use a client-side device to establish communication with a serve-side device, wherein the client-side device includes a plug-in and shows a user interface with a plurality of layers and a timeline. Next, send a plurality of multimedia files from the client-side device to the serve-side device, wherein the serve-side device includes a database, a media framework, and at least a storefront unit. Next, use the media framework to split the multimedia files respectively into the layers. Next, use the media framework to make the multimedia files synchronized on the timeline to form a digital multimedia creation. Then, save the digital multimedia creation in the database. After saving the digital multimedia creation, use the storefront unit to publish the digital multimedia creation to a consumer-side device.

### CROSS-REFERENCE TO RELATED APPLICATION

This application claims the benefit of U.S. Provisional Application No. 61/400,365,filed on Jul. 28, 2010, which is hereby incorporated by reference for all purposes as if fully set forth herein.

### BACKGROUND OF THE INVENTION

1.Field of Invention

The present invention relates to a method for editing multimedia, and more particularly to a method that enables users to edit audio, visual, and text files online.

2. Related Art

A conventional music album usually includes a booklet and a compact disc (CD). The CD contains audio files, and the booklet contains artwork, a track list, and lyrics. Most conventional music albums are made by music companies, such as Electric & Musical Industries Ltd. (EMI) and Universal Music Group (UMG), and the conventional music albums are usually sold in record shops. However, the way that record shops sell the music albums makes it difficult for the music albums distribution channel to increase further.

### SUMMARY OF THE INVENTION

Accordingly, the present invention is directed to a method for editing multimedia for increasing the music albums distribution channel.

The present invention provides a method for editing multimedia including the following steps. First, use a client-side device to establish communication with a serve-side device, wherein the client-side device includes a plug-in and shows a user interface with a plurality of layers and a timeline. Next, send a plurality of multimedia files from the client-side device to the serve-side device, wherein the serve-side device includes a database, a media framework, and at least a storefront unit. Next, use the media framework to split the multimedia files respectively into the layers. Next, use the media framework to make the multimedia files synchronized on the timeline to form a digital multimedia creation. Then, save the digital multimedia creation in the database. After saving the digital multimedia creation, use the storefront unit to publish the digital multimedia creation to the consumer-side device.

Based on the above description, the method for editing multimedia of the present invention can help a user create the digital multimedia creation and sell the digital multimedia creation, thereby increasing the music albums distribution channel.

In order to make the aforementioned features of the present invention more comprehensible, the following statement accompanied with figures are described in detail below.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a system which a method for editing multimedia is applied to according to the present invention;

FIG. 2 is a flow chart of the method for editing multimedia in FIG. 1; and

FIGS. 3-11 are drawings of a user interface shown by the serve-side device in FIG. 1.

### DETAILED DESCRIPTION OF THE INVENTION

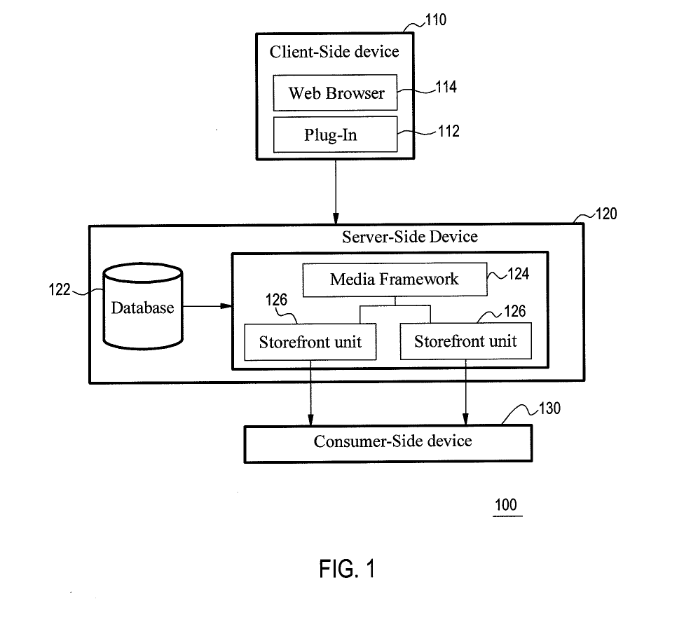

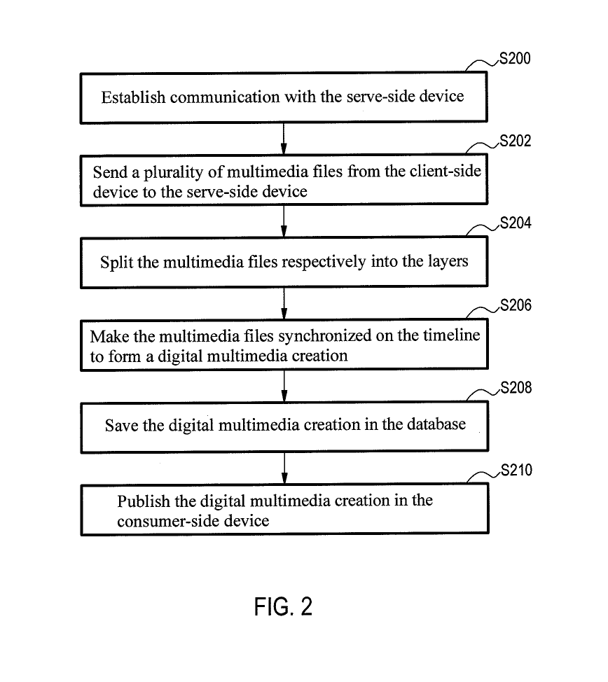

FIG. 1 is a block diagram of a system which a method for editing multimedia is applied to according to the present invention, and FIG. 2 is a flow chart of the method for editing multimedia in FIG. 1. Referring to FIG. 1 and FIG. 2, the method enables for a user such as a singer-songwriter or a musician, to edit multimedia files online and to make a digital multimedia creation containing synchronized audio, visual and text files, wherein the digital multimedia creation may be a multimedia music album.

The method of the present invention is applied to an editing system 100. The editing system 100 allows real-time client-server interactive editing for the purpose of efficient creation or audio, visual and text files editing online by the cloud computing technology. Moreover, the editing system 100 uses media streaming technology with reduced quality of multimedia file, so that the bandwidth needed during playback is small. Therefore, the user can request playback from a remote side with limited internet bandwidth, or through a wireless device.

Specifically, the editing system 100 includes a client-side device 110, a serve-side device 120, and a consumer-side device 130. The client-side device 110 is such as a desktop computer, a laptop, a mobile phone, or a personal digital assistant (PDA). The serve-side device 120 includes a database 122, a media framework 124, and at least a storefront unit 126, wherein the media framework 124, and the storefront unit 126 are both stored in the database 122. In the embodiment as shown by FIG. 1, the serve-side device 120 includes two storefront units 126, and each of the storefront units 126 may be a common storefront or a user storefront.

The method for editing multimedia of the present invention includes the following steps. First, use a client-side device 110 to establish communication with the serve-side device 120 (step S200). In detail, the client-side device 110 includes a plug-in 112 and a web browser 114. The web browser 114 may be a common web browser, such as Chrome, Internet Explorer (IE), or Mozilla Firefox, and combined with the plug-in 112. When the communication has been established, the user can send files from the client-side device 110 to the serve-side device 120 and control the media framework 124 online.

Next, send a plurality of multimedia files from the client-side device 110 to the serve-side device 120 (step S202). Specifically, the plug-in 112 and the web browser 114 both enable to establish the communication between the client-side device 110 and the serve-side device 120, and thus, the user can operate the client-side device 110 for running the plug-in 112 and the web browser 114, thereby sending the multimedia files to the serve-side device 120. After the serve-side device 120 receives the multimedia files, the multimedia files are stored in the database 122. Moreover, after the multimedia files are stored in the database 122, the serve-side device 120 can use the media streaming technology to provide the preview of the file after edited for the user immediately while performing the editing in the client-side device 110.

In addition, the multimedia files include a plurality of audio files, a plurality of visual files, and a plurality of text files, and the visual file may be an image file or a video file. Each of the audio files can be a computer file with a filename extension, such as “mp3”, “way”, “ra”, or “wma”. Each of the video files can be a computer file with a filename extension, such as “mp4”, “wmv”, or “avi”. Each of the image files can be a computer file with a filename extension, such as “jpg”, “bmp”, “gif”, “png” or “tif”. Each of the text files can be a computer file with a filename extension, such as “doc” or “txt”.

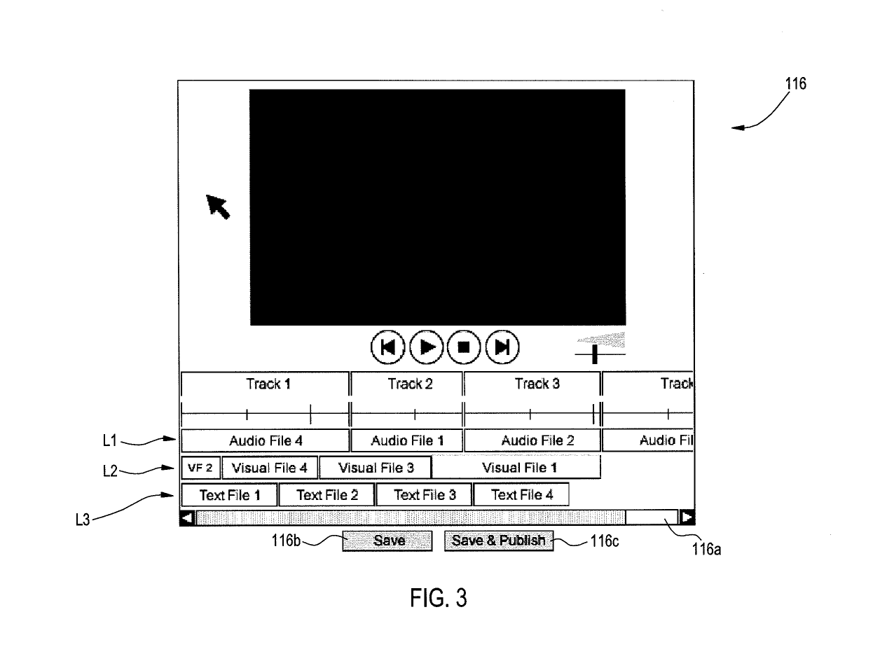

FIGS. 3-11 are drawings of a user interface shown by the serve-side device in FIG. 1. Referring to FIG. 1, FIG. 2, and FIG. 3, after the client-side device 110 has communicated with the serve-side device 120, the plug-in 112 and the web browser 114 enables the client-side device 110 to show a user interface 116 with a plurality of layers and a timeline 116a. The layers include a first layer L1, a second layer L2, and a third layer L3, as shown by FIG. 3. Moreover, the timeline 116a can serve as a visualized time indicator, and the user can move the multimedia files to any point of time on the timeline 116 within its own layer.

The timeline 116a may contain the location on the database of the inserted multimedia file, the start-end position of each inserted multimedia file and the synchronization time code. The timeline 116a, the associated information, and the editing status are being saved to the database 122 during each editing session. When playback is requested by the user, the serve-side device 120 may locate the multimedia file as recorded in the timeline and play back only a chunk of the multimedia files from the serve-side device 120 each time using the multimedia file on demand protocol.

After sending the multimedia files to the serve-side device 120, use the media framework 124 to split the multimedia files respectively into the layers L1, L2, and L3 (step S204). In detail, the user interface 116 can serve as a real-time control panel for controlling the media framework 124, and the media framework 124 is used for editing the multimedia files. Thus, the user can operate the media framework 124 through the user interface 116 to split the multimedia files respectively.

After the step of splitting the multimedia files, the audio files are shown in the first layer L1, the visual files are shown in the second layer L2, and the text files are shown in the third layer L3. Specifically, the layers (i.e. the first layer L1, the second layer L2, and the third layer L3) categorize the multimedia files according to format. Each of the layers is a visualized way to group multimedia files. In addition, each of the layers can show the location of the multimedia files on the timeline 116a, the start-end position of each multimedia files and the synchronization time code, as shown by FIG. 3.

Next, the user can use the media framework 124 to make the multimedia files synchronized on the timeline 116a to form a digital multimedia creation (step S206), wherein the timeline 116a can show the total duration length of the digital multimedia creation from the beginning to the end, and sequences of the multimedia files. In one of the embodiments, the total duration length of the multimedia music album from the beginning of the first multimedia file to the end of the last multimedia file may be shown on the timeline in “Hour:Minute:Second.millisecond format”.

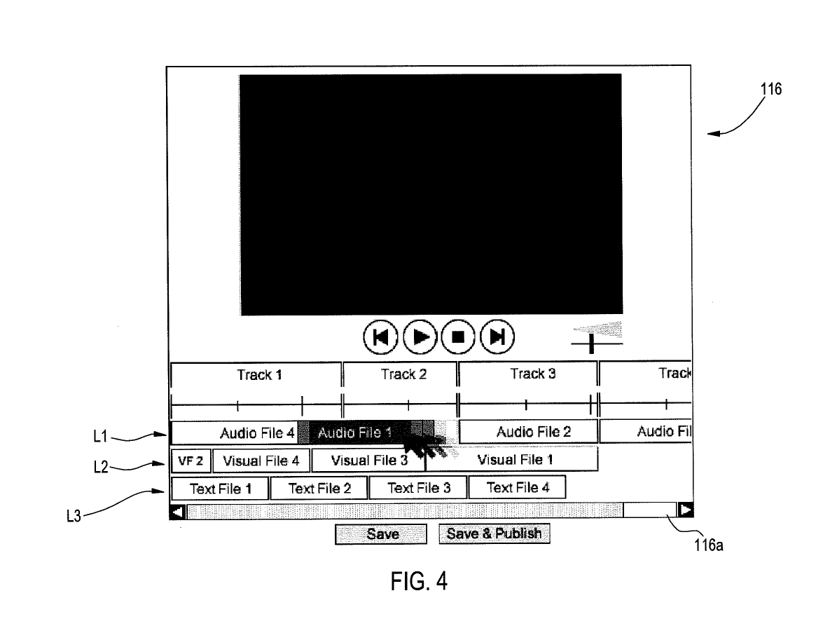

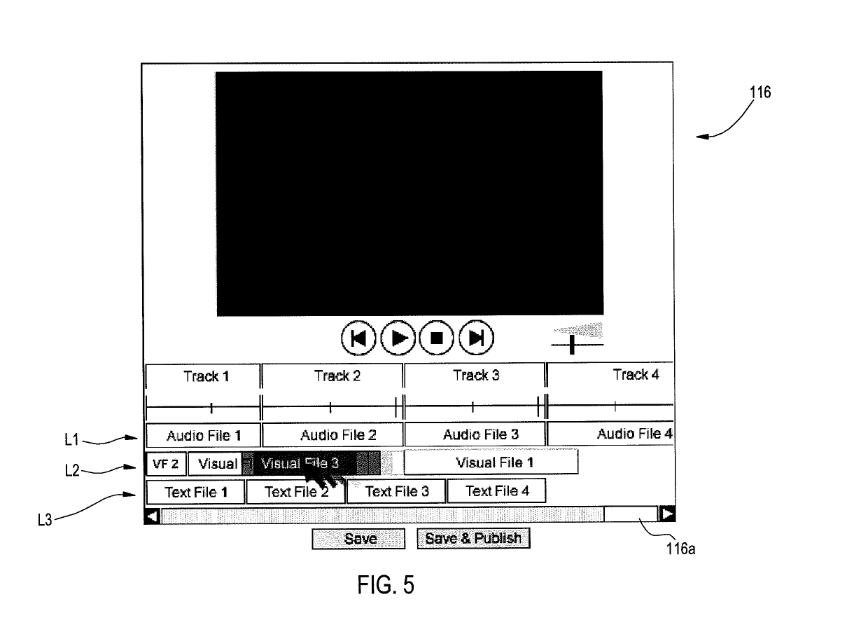

Referring to FIG. 4 and FIG. 5, the step of making the multimedia files synchronized on the timeline can include the following steps for arranging the multimedia files. Specifically, the user can use the media framework 124 through the user interface 116 to arrange a sequence of the audio files on the timeline 116a, as shown by FIG. 4, to arrange a sequence of the visual files on the timeline 116a, as shown by FIG. 5, and to arrange a sequence of the text files on the timeline 116a. Therefore, the user can determine which of the multimedia files is played at first, and which of the multimedia files is played at the end.

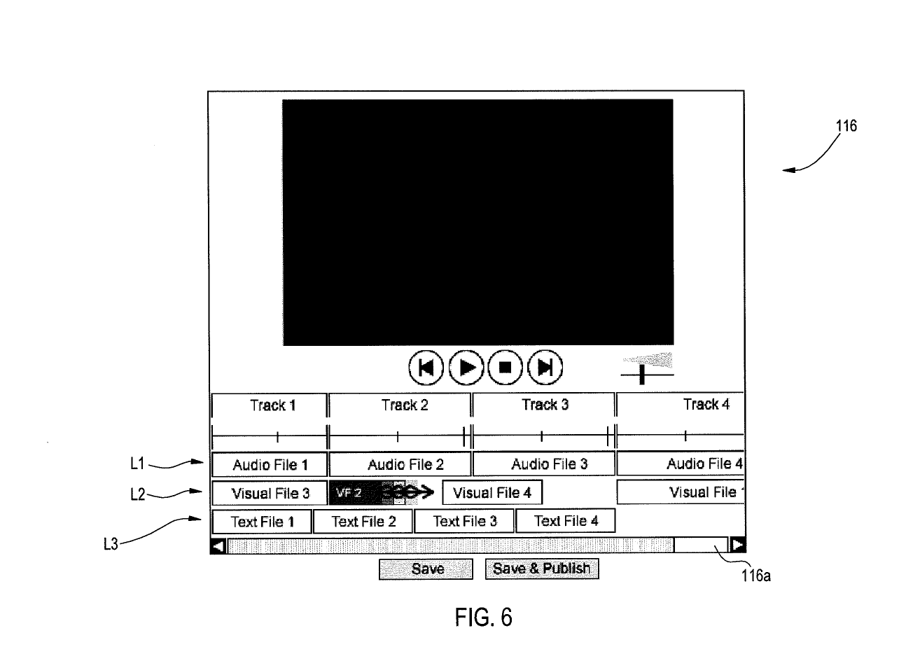

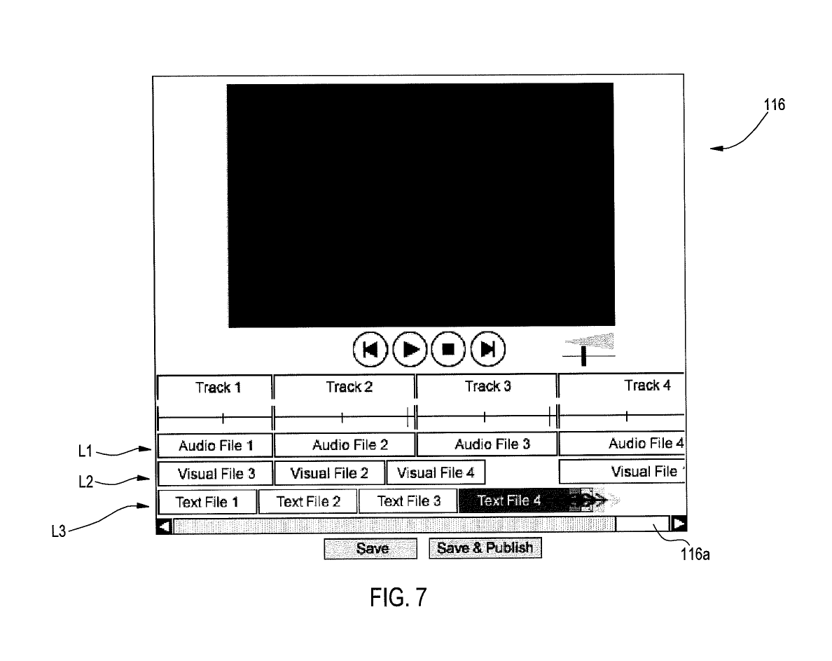

Referring to FIG. 6, when the multimedia files are made synchronized on the timeline 116a, the user can use the media framework 124 to adjust a duration length of one of the multimedia files. In detail, taking FIG. 6 for example, when one of the visual files is an image file, the user can use the media framework 124 to adjust a duration length of the image file, thereby extending or shortening the duration length of the image file. Similarly, referring to FIG. 7 and taking FIG. 7 for example, the user also can use the media framework 124 to adjust a duration length of the text file, thereby extending or shortening the duration length of the text file.

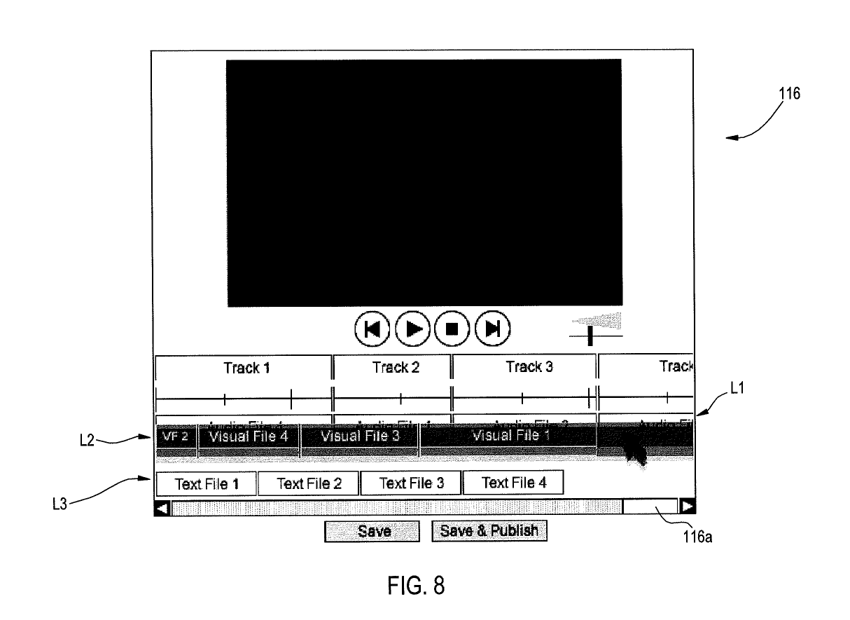

Referring to FIG. 8, during making the multimedia files synchronized on the timeline 116a, the user also can use the media framework 124 to determine a primary layer from the first layer L1 and the second layer L2. That is to say, the primary layer is defined by the user. The primary layer acts as the master when working on synchronization, and other layers act as the slave.

In a preferred embodiment of the present invention, the layer on top shown by the user interface 116 is the primary layer, and the multimedia files in the primary layer are primary media. The user can use the media framework 124 through the user interface 116 to move one of the first layer L1 and the second layer L2 for determining the primary layer. Taking FIG. 8 for example, the user chooses the second layer L2 as the primary layer.

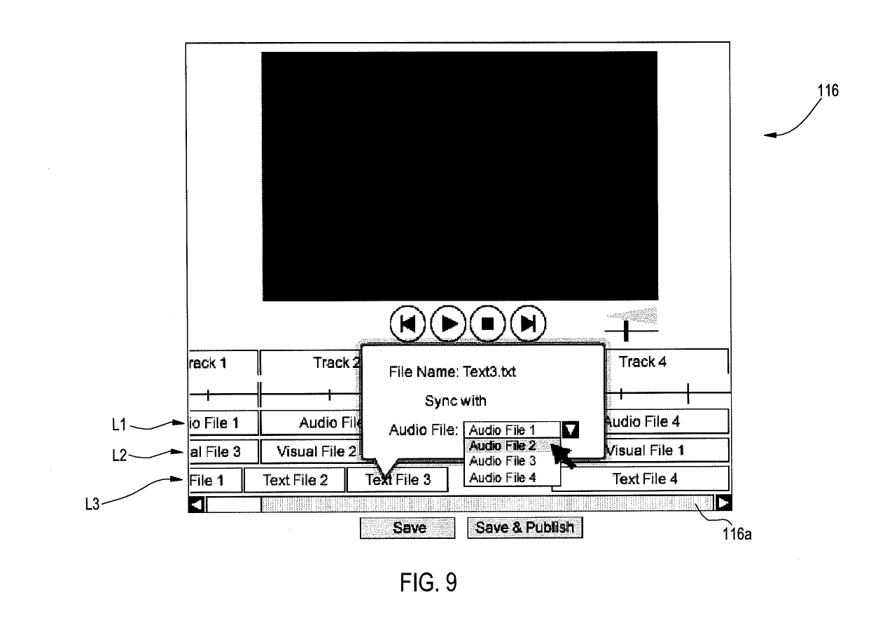

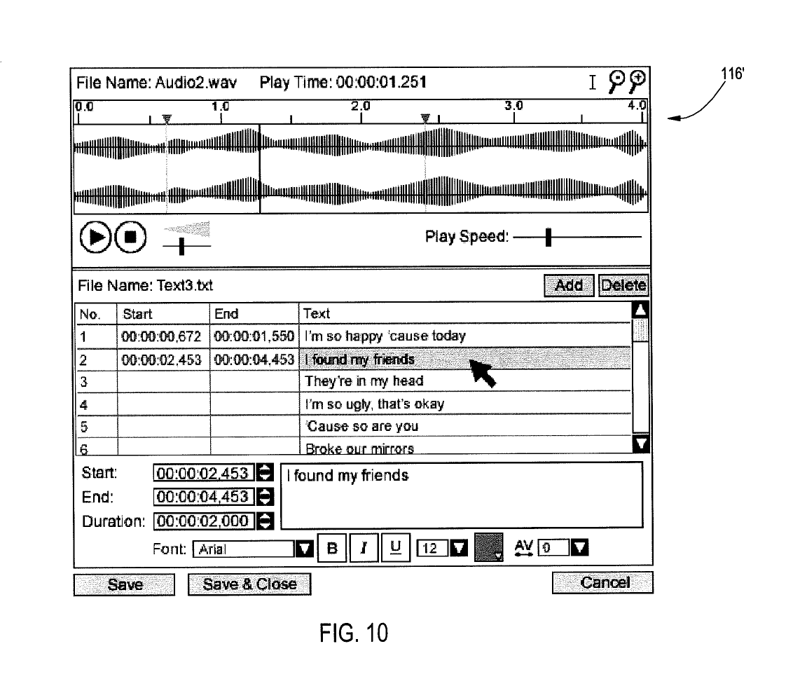

Referring to FIG. 9 and FIG. 10, after determining the primary layer, the user can use the media framework 124 to fit the multimedia files of the primary layer to the text files in the third layer L3 through the user interfaces 116 and 116′. Taking FIG. 9 and FIG. 10 for example, when the user fits the audio flies in the first layer L1 to the text files in the third layer L3, the user interface 116 will change into the user interface 116′, wherein the user interface 116′ is used to help the user to synchronize the audio flies with the text files.

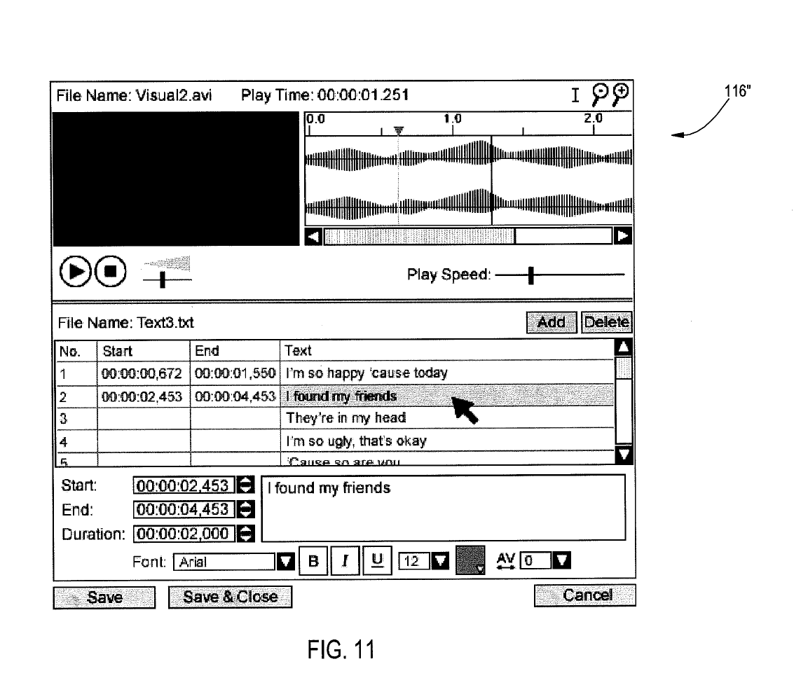

Referring to FIG. 11, in addition to synchronizing the audio flies with the text files, the user also can fit the visual flies to the text files through the user interface 116″. Specifically, the user interface 116 can change into the user interface 116″, and the user interface 116″ is used to help the user to synchronize the visual flies with the text files. It should be noted that the text files may serve as subtitles for a video such as a music video (MV) or a movie.

Referring to FIG. 1, FIG. 2, and FIG. 3, after forming the digital multimedia creation, the user can save the digital multimedia creation in the database 122 (step S208). Specifically, the user can operate the user interface 116 to make the database 122 save the digital multimedia creation. Taking FIG. 3 for example, the user can click the bottom 116b, which shows “Save”, for saving the digital multimedia creation. In addition, the editing status of the digital multimedia creation can be saved to the database 122 during making the multimedia files synchronized. That is to say, the editing status is saved to the database 122 during each editing session.

Referring to FIG. 1, FIG. 2, and FIG. 3, after saving the digital multimedia creation, the storefront unit 126 can publish the digital multimedia creation to the consumer-side device 130 (step S210). Specifically, the user can operate the user interface 116 to make at least one of the storefront units 126 publish the digital multimedia creation. Taking FIG. 3 for example, the user can click the bottom 116c, which shows “Save & Publish”, for saving and publishing the digital multimedia creation.

Additionally, when saving the digital multimedia creation, the timeline 116a in the digital multimedia creation will be saved. When a consumer wants to buy a complete digital multimedia creation, the serve-side device 120 will find a according timeline and generate the digital multimedia creation according to the information of the timeline.

On the basis of the above description, the method for editing multimedia of the present invention can help a user such as a singer-songwriter or a musician, to edit or to create a digital multimedia creation including synchronized audio, visual and text files, and help the user to sell the digital multimedia creation through at least a storefront unit. Therefore, the present invention can increase the music albums distribution channel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for editing multimedia, comprising the following steps of:
using a client-side device to establish communication with a serve-side device, wherein the client-side device comprises a plug-in and shows a user interface with a plurality of layers and a timeline;
sending a plurality of multimedia files from the client-side device to the serve-side device, wherein the serve-side device comprises a database, a media framework, and at least a storefront unit;
using the media framework to split the multimedia files respectively into the layers;
using the media framework to make the multimedia files synchronized on the timeline to form a digital multimedia creation ;
saving the digital multimedia creation in the database; and
after saving the digital multimedia creation, using the storefront unit to publish the digital multimedia creation to the consumer-side device.

2. The method for editing multimedia according to claim 1, wherein the step of making the multimedia files synchronized on the timeline comprises adjusting a duration length of one of the multimedia files.

3. The method for editing multimedia according to claim 1, wherein the multimedia files comprise a plurality of audio files, a plurality of visual files, and a plurality of text files, and the layers comprises a first layer, a second layer, and a third layer; after the step of splitting the multimedia files, the audio files are shown in the first layer, the visual files are shown in the second layer, and the text files are shown in the third layer.

4. The method for editing multimedia according to claim 3, wherein the step of making the multimedia files synchronized on the timeline comprises:
arranging a sequence of the audio files on the timeline;
arranging a sequence of the visual files on the timeline; and
arranging a sequence of the text files on the timeline.

5. The method for editing multimedia according to claim 3, wherein the step of making the multimedia files synchronized on the timeline comprises:
determining a primary layer from the first layer and the second layer; and
fitting the multimedia files of the primary layer to the text files.

6. The method for editing multimedia according to claim 5, wherein the step of determining a primary layer from the first layer and the second layer comprises moving one of the first layer and the second layer.

7. The method for editing multimedia according to claim 3, wherein the visual file is an image file or a video file.

8. The method for editing multimedia according to claim 1, wherein the client-side device further comprises a web browser combining with the plug-in.

9. The method for editing multimedia according to claim 1, wherein the storefront unit is a common storefront or a user storefront.
